(19) United States
(12) Patent Application Publication
(10) Pub. No.: US 2008/0001955 A1
(43) Pub. Date: Jan. 3, 2008

(54) Video output system with co-layout structure

(75) Inventor: Kuo-Liang Tsai, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/476,812

(22) Filed: Jun. 29, 2006

(51) Int. Cl. G06F 13/14

(52) U.S. Cl. 345/520

(57) ABSTRACT

A video output system with co-layout structure includes an internal video graphics array (VGA) interface, an external VGA interface and a video output interface. The two VGA interfaces are connected to a connection point through individual leads respectively, then to the video output interface at the connection point through a common lead. The video output system further includes two switches disposed between the internal VGA interface and the connection point and between the external VGA interface and the connection point respectively for blocking the signal stub from flowing to the two VGA interfaces, thereby enhancing the signal quality.

### BACKGROUND OF THE INVENTION

1. Field of Invention

The present invention relates to a video output system, and more particularly to a video output system capable of improving video quality and having a simple process.

2. Related Art

Generally, the information processed by a graphics card is finally output to a display. The output interface of the graphics card is a bridge between computer and display, and is used for outputting corresponding graphic signals to the display. Due to its design and fabrication, a cathode ray tube display can only receive analog signal input, and therefore there is a need for a graphics card suitable for inputting analog signals. A Video Graphics Array (VGA) interface, also called a D-Sub interface, is an interface on the graphics card for outputting analog signals. Most computers and external display devices are connected together through analog VGA interfaces. The display graphic information generated in digital form by the computer is converted into three primary color signals red (R), green (G), and blue (B), and horizontal synchronization (HS) and vertical synchronization (VS) scan signals through a digital/analog converter in the graphics card, and the signals are transmitted to the display device through a cable by the VGA interface. The VGA interface has 15 pins (divided into 3 rows of 5 pins each), and adopts a progressive output method. At present, the VGA interface is the most widely used interface on graphics cards, and most graphics cards are provided with this interface.

FIG. 1 is a schematic view showing the connection relationship among an internal VGA interface 101, an external VGA interface 103, and a video output interface 105 in the video output system of the prior art. The internal VGA interface 101 and the external VGA interface 103 are connected to the video output interface 105 respectively. The two VGA interfaces are connected to a connection point A 100 through individual leads respectively, and then to the video output interface 105 at the connection point A 100 through a common lead.

The operating principle of the video output system shown in FIG. 1 is described as follows. When the personal computer (PC) sends an instruction, a VGA interface delivers signals in response to the instruction of the PC; for example, the internal VGA interface 101 operates (herein only one VGA interface will operate). However, when delivering signals, since the signal lines of the internal VGA interface 101 and the external VGA interface 103 are connected together directly, a small portion of signal remains in the lead between the non-operative VGA interface (the external VGA interface 103) interface and the connection point A 100, causing a signal stub, creating a reflection, thus degrading the signal quality, and influencing graphic display.

Therefore, how to address the problem of signal stub has become one of the crucial problems of improving the quality of graphic display, and is also a technological bottleneck which has received the constant attention of those in the field.

### SUMMARY OF THE INVENTION

In view of the above problems, the present invention provides a video output system capable of reducing signal stub and having a simple process.

Accordingly, in order to achieve the above object, the present invention provides a video output system with a co-layout structure, which comprises an internal VGA interface, an external VGA interface, and a video output interface. The two VGA interfaces are connected to a connection point through individual leads respectively, and then to the video output interface at the connection point through a common lead. The video output system further includes two switches disposed between the internal VGA interface and the connection point and between the external VGA interface and the connection point respectively for blocking signal stub from flowing to the two VGA interfaces, thereby enhancing signal quality.

The video output system described in the present invention reduces signal stub by adding switches between the internal VGA interface and the connection point, and between the external VGA interface and the connection point respectively, thus avoiding the reflection caused when the VGA interface sends signals in response to the instructions of the PC, thereby enhancing signal quality and graphic display. Moreover, the internal VGA interface, the external VGA interface, and the switches of the video output system of the present invention can be arranged on the same substrate, in what is well known as a co-layout. Therefore, these elements can be manufactured on one substrate in the production line. The process is simple and convenient, and saves costs.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and thus are not limitative of the present invention, and wherein:

FIG. 1 is a schematic view showing the connection relationships of the video output system of the prior art;

FIG. 2 is a schematic view showing the connection relationships of the video output system in the first embodiment of the present invention;

FIG. 3 is a schematic view showing the connection relationships of the video output system in the second embodiment of the present invention; and

FIG. 4 is a schematic view showing the connection relationships of the switches with the control unit of the present invention.

### DETAILED DESCRIPTION OF THE INVENTION

The preferable embodiment of the present invention is described in details below with reference to the accompanying drawings.

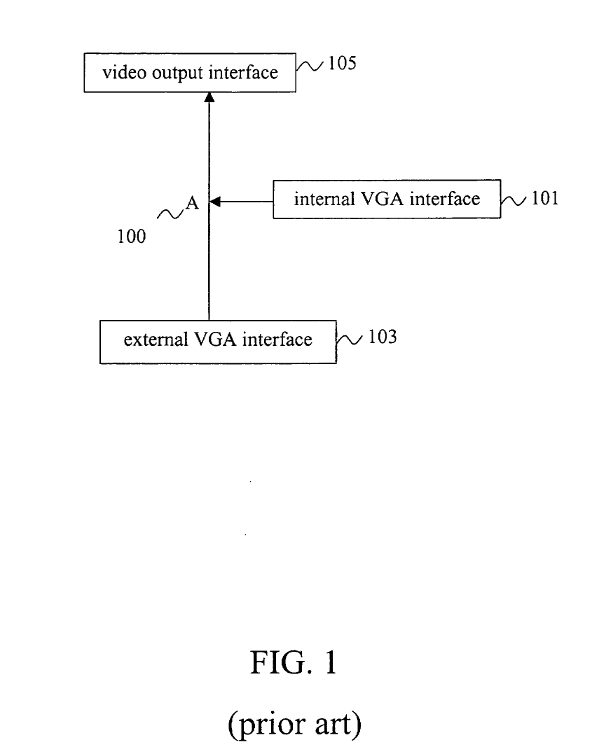

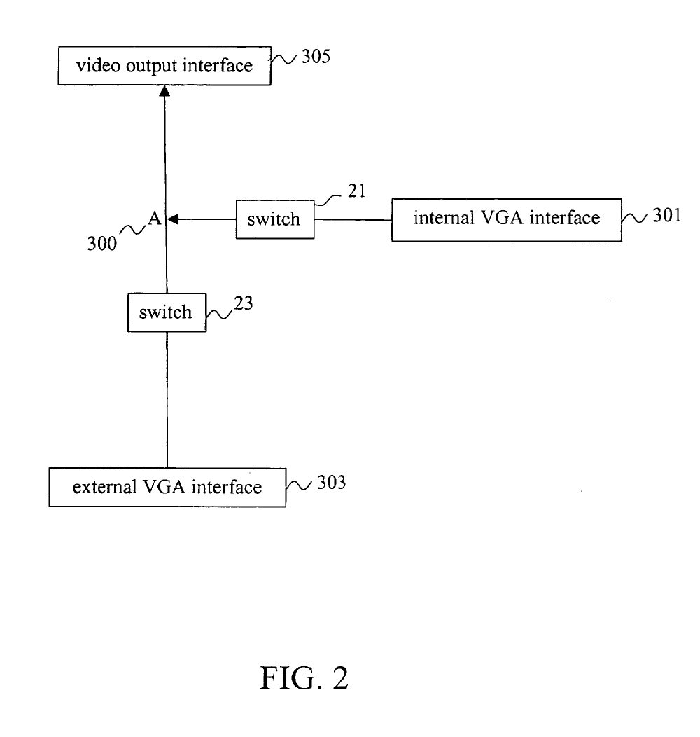

Referring to FIG. 2, it shows a video output system in the first embodiment of the present invention. Similar to the video output system of the prior art shown in FIG. 1, the video output system comprises an internal VGA interface 301, an external VGA interface 303, and a video output interface 305. The internal VGA interface 301 and the external VGA interface 303 are connected to the video output interface 305 respectively in the way of being connected to a connection point A 300 through individual leads respectively, and then to the video output interface 305 at the connection point A 300 through a common lead. The internal VGA interface 301 and the external VGA interface 303 are built-to-order, realizing a more flexible arrangement. What is different from the video output system of the prior art shown in FIG. 1 is that switches 21, 23 are respectively added on the leads through which the internal VGA interface 301 and the external interface VGA 303 are connected to the connection point A 300.

The operating principle of the video output system of the present invention shown in FIG. 2 is described as follows. When a PC sends an instruction, a VGA interface (for example, the internal VGA interface 301) delivers signals in response to the instruction of the PC (herein, only one VGA interface will operate). Before delivery of signals to the video output interface 305 by the internal VGA interface 301, the switch 21 between the internal VGA interface 301 and the connection point A 300 is turned on, and the switch 23 between the non-operative VGA interface (i.e. the external VGA interface 303) and the connection point A 300 is turned off, such that the signals are delivered to the video output interface from the internal VGA interface, and meanwhile a small portion of the signal stub is prevented from remaining in the lead between the external VGA interface 303 and the switch 23. In the same way, when the external VGA interface 303 receives an instruction sent by the PC, it delivers signals according to the method described above.

The present invention employs the technique of respectively adding switches 21, 23 on the leads through which the internal VGA interface 301 and the external VGA interface 303 are connected to the connection point A 300. When the internal VGA interface 301 operates, the switch 21 between the internal VGA interface 301 and the connection point A 300 is turned on, and the switch 23 between the non-operative external VGA interface 303 and the connection point A 300 is turned off, such that the operative internal VGA interface 301 can transmit signals to the video output interface 305 successfully. Also, after the signal transmission is completed, since the switch 23 between the non-operative external VGA interface 303 and the connection point A 300 is turned off, the signal stub remains only in the lead between the connection point A 300 and the switch 23. Compared with the prior art in which the signal stub remains in the lead between the connection point A 100 and the non-operative VGA interface, the signal stub in the lead between the non-operative VGA interface and the switch is reduced according to the invention, i.e. the length of the lead with signal stub is reduced (by the length of the lead between the non-operative external VGA interface 303 and the switch 23), and thus the amount of signal stub remaining in this part of lead is reduced. Therefore, when the external VGA interface 303, which did not operate this time, transmits signals upon receiving its next instruction, the influence of the previous signal stub to this signal transmission is reduced, thereby improving signal quality.

The switches 21, 23 can be disposed as close to connection point A 300 as possible. But obviously, there should be a certain distance, thus ensuring that the least possible signal stub remains in the leads between the switches 21, 23 and the connection point A 300. The switches 21, 23 can be switchable on and off, and the purpose of blocking signal flow direction can be achieved by the on and off of the switches.

In the first embodiment of the present invention, all elements can be formed on the same substrate, which is well known as a co-layout.

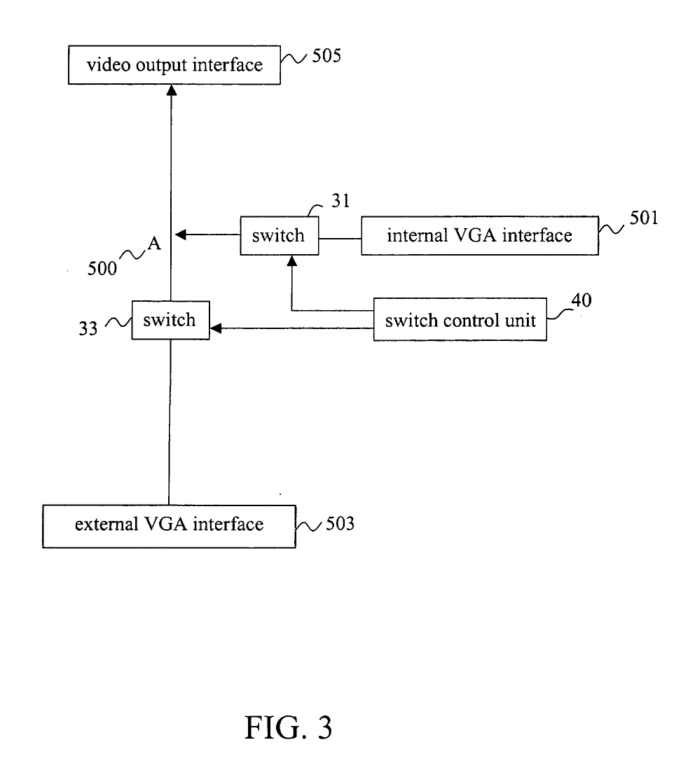

Referring to FIG. 3, it shows a video output system in the second embodiment of the present invention, which is similar to the video output system shown in the first embodiment, except that a switch control unit 40 is additionally connected to the two switches 31, 33 respectively. The switch control unit 40 further comprises an ID control pin, so as to select modes freely. When the external VGA interface 503 transmits signals to the video output interface 505 through a connection point A 500 upon receiving an instruction of the PC, the switch control unit 40 may turn off the switch 31 connected with the internal VGA interface 501 and turn on the switch 33 connected with the external VGA interface 503 automatically or manually by the user, thereby realizing the signal transmission, and vice versa.

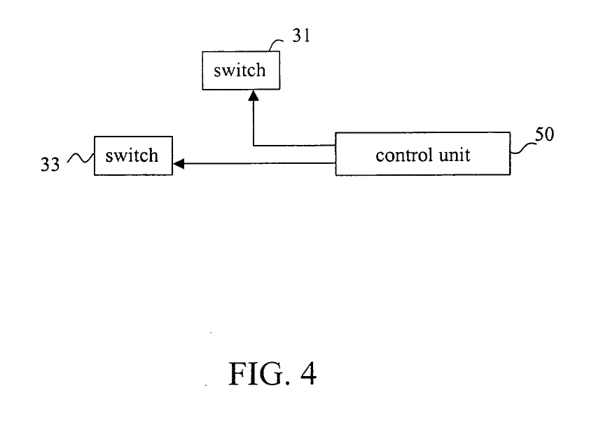

Referring to FIG. 4, it shows the connection relationships of the switches with a control unit of the present invention. The switch can be a zero ohm resistor. When the switch is a zero ohm resistor, the control unit 50 must be disposed inside or outside for fusing the resistor to cut off the connection thoroughly, thus blocking the flow direction of the signal. However, in this method, once the resistor is fused, the VGA interface cannot operate any more. Furthermore, the switch can be any combination of the zero ohm resistor and common switch as desired.

The video output system described in the present invention is suitable for greatly reducing signal stub by adding switches between the internal VGA interface and the connection point A and between the external VGA interface and the connection point A respectively, thus avoiding the reflection caused by signal stub as much as possible, enhancing signal quality and improving the graphic display. Especially, the disposed switch control unit allows the user to select modes freely, thus improving convenience. Moreover, all elements including switches can be formed on the same substrate. The process is simple, reducing the increased costs of using multiple substrates, and increasing productivity.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A video output system with co-layout structure, comprising an internal video graphics array (VGA) interface, an external VGA interface, and a video output interface, the internal VGA interface and the external VGA interface being connected to a connection point through individual leads respectively, and to the video output interface at the connection point through a common lead, wherein:
the video output system further comprises two switches located between the internal VGA interface and the connection point and between the external VGA interface and the connection point respectively, for blocking signal stub from flowing to the internal VGA interface and the external VGA interface, thereby enhancing signal quality.

2. The video output system with co-layout structure as claimed in claim 1, wherein the two switches are disposed at the positions closest to the internal VGA interface and the external VGA interface.

3. The video output system with co-layout structure as claimed in claim 1, wherein both of the two switches are on-off switches.

4. The video output system with co-layout structure as claimed in claim 3, wherein the video output system further comprises a switch control unit connected with the two switches respectively for controlling the on and off of the two switches.

5. The video output system with co-layout structure as claimed in claim 4, wherein the switch control unit further comprises an ID control pin for selecting modes.

6. The video output system having co-layout structure as claimed in claim 1, wherein both of the two switches are zero ohm resistors.

7. The video output system with co-layout structure as claimed in claim 6, wherein the video output system further comprises a control unit connected with the two switches respectively for fusing the zero ohm resistors.
